(19) United States
(12) Patent Application Publication
(10) Pub. No.: US 2009/0080502 A1
(43) Pub. Date: Mar. 26, 2009

(54) METHOD AND SYSTEM FOR DISTRIBUTED TRANSCEIVERS BASED ON RF QUADRATURE AND LO QUADRATURE FILTERING FOR HIGH FREQUENCY APPLICATIONS

(76) Inventors: Ahmadreza Rofougaran, Newport Coast, CA (US); Maryam Rofougaran, Rancho Palos Verdes, CA (US)

Correspondence Address: MCANDREWS HELD & MALLOY, LTD, 500 WEST MADISON STREET, SUITE 3400, CHICAGO, IL, 60661, US

(21) Appl. No.: 11/860,234

(22) Filed: Sep. 24, 2007

(51) Int. Cl. H04B 1/38

(52) U.S. Cl. 375/219

(57) ABSTRACT

Aspects of a method and system for distributed quadrature transceiver using phase shifting may include frequency-translating a first signal to generate a second signal and a third signal, utilizing a plurality of conversion stages, wherein in at least one of said plurality of conversion stages, a first frequency scaled signal and a second frequency scaled signal may be summed. A third frequency scaled signal and a fourth frequency scaled signal may be summed. The first signal may be the corresponding input signal to at least one of the plurality of conversion stages, and the second signal and the third signal may be generated from one or more output signals of the plurality of conversion stages.

### CROSS-REFERENCE TO RELATED APPLICATIONS/INCORPORATION BY REFERENCE

This application makes reference to:
U.S. application Ser. No. ______ (Attorney Docket No. 18758US01), filed on even date herewith;
U.S. application Ser. No. ______ (Attorney Docket No. 18760US01), filed on even date herewith;
U.S. application Ser. No. ______ (Attorney Docket No. 18761US01), filed on even date herewith;
U.S. application Ser. No. ______ (Attorney Docket No. 18762US01), filed on even date herewith; and
U.S. application Ser. No. ______ (Attorney Docket No. 18766US01), filed on even date herewith.

Each of the above referenced applications is hereby incorporated herein by reference in its entirety.

### FIELD OF THE INVENTION

Certain embodiments of the invention relate to signal processing for communication systems. More specifically, certain embodiments of the invention relate to a method and system for distributed transceivers based on RF quadrature and LO quadrature filtering for high frequency applications.

### BACKGROUND OF THE INVENTION

In 2001, the Federal Communications Commission (FCC) designated a large contiguous block of 7 GHz bandwidth for communications in the 57 GHz to 64 GHz spectrum. This frequency band was designated for use on an unlicensed basis, that is, the spectrum is accessible to anyone, subject to certain basic, technical restrictions such as maximum transmission power and certain coexistence mechanisms. The communications taking place in this band are often referred to as ‘60 GHz communications’.

With respect to the accessibility of this designated portion of the spectrum, 60 GHz communications is similar to other forms of unlicensed spectrum use, for example Wireless LANs or Bluetooth in the 2.4 GHz ISM bands. However, communications at 60 GHz may be significantly different in aspects other than accessibility. For example, 60 GHz signals may provide markedly different communications channel and propagation characteristics, at least due to the fact that 60 GHz radiation is partly absorbed by oxygen in the air, leading to higher attenuation with distance. On the other hand, since a very large bandwidth of 7 GHz is available, very high data rates may be achieved. Among the applications for 60 GHz communications are wireless personal area networks, wireless high-definition television signal, for example from a set top box to a display, or Point-to-Point links.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for distributed transceivers based on RF quadrature and LO quadrature filtering for high frequency applications, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary wireless communication system, in connection with an embodiment of the invention.

FIG. 2 is a block diagram of an exemplary RF demodulator for a high-frequency receiver, in accordance with an embodiment of the invention.

FIG. 3 is a block diagram of an exemplary RF modulator and demodulator for a high-frequency transceiver, in accordance with an embodiment of the invention.

FIG. 4 is a flowchart, illustrating an exemplary determination of the down conversion factors of a demodulator, in accordance with an embodiment of the invention.

FIG. 5 is a diagram of an exemplary demodulator with local oscillator frequency mixing, in accordance with an embodiment of the invention.

### DETAILED DESCRIPTION OF THE INVENTION

Certain embodiments of the invention may be found in a method and system for distributed transceivers based on RF quadrature and LO quadrature filtering for high frequency applications. Aspects of a method and system for distributed transceivers based on RF quadrature and LO quadrature filtering for high frequency applications may comprise frequency-translating a first signal to generate a second signal and a third signal, utilizing a plurality of conversion stages, wherein in at least one of said plurality of conversion stages, a first frequency scaled signal and a second frequency scaled signal may be summed. The first frequency scaled signal may be generated by multiplying a corresponding input signal with a local oscillator signal or a fractional local oscillator signal, and the second frequency scaled signal may be generated by multiplying a phase-shifted version of the corresponding input signal with a phase-shifted version of the local oscillator signal or a phase-shifted version of the fractional local oscillator signal. A third frequency scaled signal and a fourth frequency scaled signal may be summed. The third frequency scaled signal may be generated by multiplying the corresponding input signal with the phase-shifted version of the local oscillator signal or the phase-shifted version of the fractional local oscillator signal, and the fourth frequency scaled signal may be generated by multiplying the phase-shifted version of the corresponding input signal with the local oscillator signal or the fractional local oscillator signal. The first signal may be the corresponding input signal to at least one of the plurality of conversion stages, and the second signal and the third signal may be generated from one or more output signals of the plurality of conversion stages.

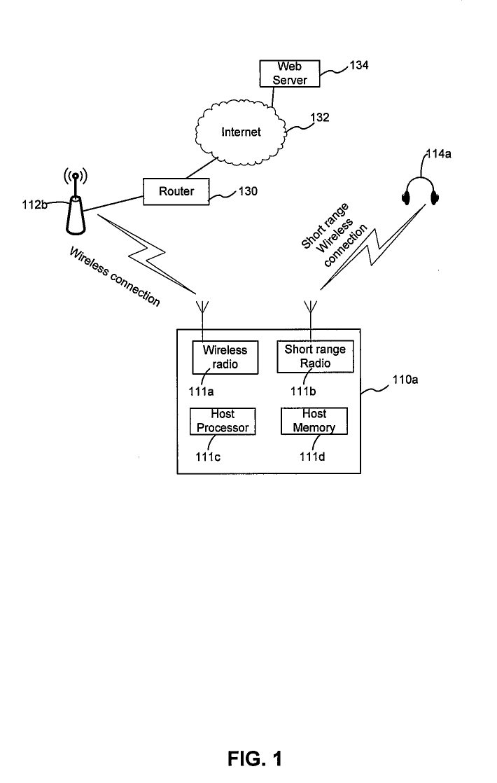

FIG. 1 is a diagram illustrating an exemplary wireless communication system, in connection with an embodiment of the invention. Referring to FIG. 1, there is shown an access point 112b, a computer 110a, a headset 114a, a router 130, the Internet 132 and a web server 134. The computer or host device 110a may comprise a wireless radio 111a, a short-range radio 111b, a host processor 111c, and a host memory 111d. There is also shown a wireless connection between the wireless radio 111a and the access point 112b, and a short-range wireless connection between the short-range radio 111b and the headset 114a.

Frequently, computing and communication devices may comprise hardware and software to communicate using multiple wireless communication standards. The wireless radio 111a may be compliant with a mobile communications standard, for example. There may be instances when the wireless radio 111a and the short-range radio 111b may be active concurrently. For example, it may be desirable for a user of the computer or host device 110a to access the Internet 132 in order to consume streaming content from the Web server 134. Accordingly, the user may establish a wireless connection between the computer 110a and the access point 112b. Once this connection is established, the streaming content from the Web server 134 may be received via the router 130, the access point 112b, and the wireless connection, and consumed by the computer or host device 110a.

It may be further desirable for the user of the computer 110a to listen to an audio portion of the streaming content on the headset 114a. Accordingly, the user of the computer 110a may establish a short-range wireless connection with the headset 114a. Once the short-range wireless connection is established, and with suitable configurations on the computer enabled, the audio portion of the streaming content may be consumed by the headset 114a. In instances where such advanced communication systems are integrated or located within the host device 110a, the radio frequency (RF) generation may support fast-switching to enable support of multiple communication standards and/or advanced wideband systems like, for example, Ultrawideband (UWB) radio. Other applications of short-range communications may be wireless High-Definition TV (W-HDTV), from a set top box to a video display, for example. W-HDTV may require high data rates that may be achieved with large bandwidth communication technologies, for example UWB and/or 60-GHz communications.

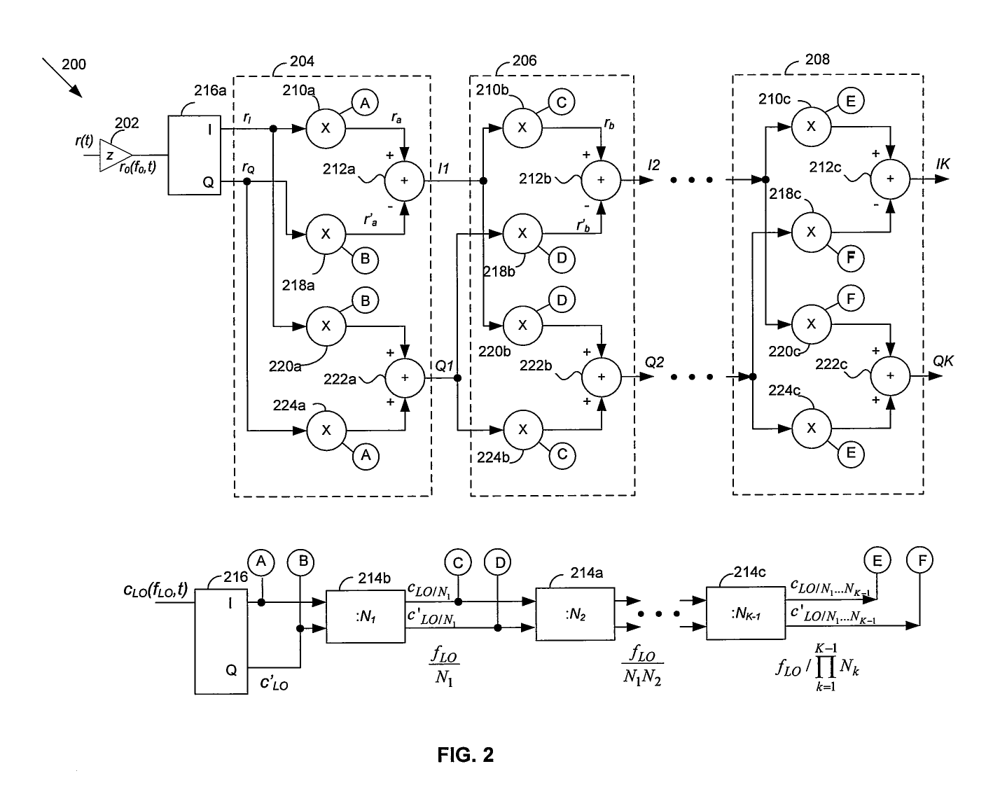

FIG. 2 is a block diagram of an exemplary RF demodulator for a high-frequency receiver, in accordance with an embodiment of the invention. Referring to FIG. 2, there is shown a demodulator 200 comprising an amplifier 202, quadrature generator 216 and 216a, a plurality of frequency dividers, of which frequency dividers 214a/b/c are illustrated, and a plurality of down conversion stages, of which down conversion stages 204, 206 and 208 are illustrated. The down conversion stage 204 may comprise multipliers 210a, 218a, 220a and 224a, and adders 212a and 222a. Down conversion stage 206 may comprise multipliers 210b, 218b, 220b and 224b, and adders 212b and 222b. Down conversion stage 208 may comprise multipliers 210c, 218c, 220c and 224c, and adders 212c and 222c. There is also shown a received signal r(t) and an amplified received signal r₀(f₀,t)=r₀=z·r(t) that may be a function of a carrier frequency f₀ and time t and an amplification factor z due to amplification by the amplifier 202. The indices for frequency and time may be dropped for illustrative purposes. Similarly, there is shown rₐ,r′ₐ,I1,I2,IK,Q1,Q2,QK,r_{I},r_{Q}. A local oscillator signal c_{LO}(f_{LO},t)=c_{LO} and a number of frequency terms

$$\frac{{f}_{LO}}{{N}_{1}} , \frac{{f}_{LO}}{{N}_{1} {N}_{2}} and \frac{{f}_{LO}}{{\prod }_{k = 1}^{K} {N}_{k}}$$

may be shown, which may illustrate various signals generated by frequency dividing the local oscillator (LO) signal c_{LO}. For example, there is also shown a plurality of frequency-divided local oscillator signals, for example,

$${c}_{LO / {N}_{1}} = {c}_{LO / {N}_{1}} ( \frac{{f}_{LO}}{{N}_{1}} , t ) .$$

There is also shown a plurality of connector labels ‘A’ through ‘F’. The connector labels may illustrate connections in the diagram, which are not shown. For example, the in-phase output of the quadrature generator 216 is connected to the multipliers 210a and 224a via the connector label ‘A’.

The amplifier 202 may comprise suitable logic, circuitry and/or code that may be enabled to amplify a high-frequency RF signal at its input by a factor z. The down conversion stages 204, 206 and 208 may be substantially similar and may comprise suitable logic, circuitry and/or code that may be enabled to down convert an input signal that may be modulated onto an RF carrier signal to an output signal that may be similar to the input signal but modulated onto lower frequency carrier signal. The multipliers 210a/b/c, 218a/b/c, 220a/b/c and 224a/b/c may comprise suitable logic, circuitry and/or code that may be enabled to multiply two RF input signals and generate an RF output signal that may be proportional to the product of its input signals. The quadrature generators 216 and 216a may comprise suitable logic, circuitry and/or code that may be enabled to generate an output signal that may be a carrier phase-shifted version of an input signal. If the frequency of the envelope of the input signal is significantly smaller than the carrier frequency, the quadrature generator may substantially shift only the carrier component.

The quadrature generator 216 may be, for example, coupled to an input signal s(t)cos(w_{c}t), where s(t) may represent the signal envelope and cos(w_{c}t) may be the carrier signal. If the highest significant frequency component in s(t) is significantly smaller than w_{c}, the in-phase output signal of the quadrature generator may be s(t)cos(w_{c}t) and the quadrature output of the quadrature generator may be s(t)cos(w_{c}t+π/2), for example. In some instances, for example due to a different implementation of the quadrature generator, the in-phase output signal of the quadrature generator may be s(t)cos(w_{c}t−π/4) and the quadrature output of the quadrature generator may be s(t)cos(w_{c}t+π/4). Hence, the output signals may be, for example, 90 degrees phase-shifted in the carrier. For illustrative purposes, the in-phase output may be considered equal to the input signal and the quadrature signal may be considered 90 degrees phase shifted from the input signal.

In some instances, a frequency divider may also be used to provide quadrature and in-phase output signals as described above. For example, if the input signal has a 50-50 duty cycle, the output signal of a flip-flop frequency divider may provide quadrature outputs as described above. The adders 212a/b/c and 222a/b/c may comprise suitable logic, circuitry and/or code that may be enabled to sum a plurality of input signals into an output signal. The frequency dividers 214a/b/c may comprise suitable logic, circuitry and/or code that may be enabled to generate an output signal that may be similar to its input signal, divided in frequency. The frequency dividers may be implemented using Direct Digital Frequency Synthesis or integer (Miller) dividers, for example.

With reference to FIG. 2, there is shown a demodulator 200 that may be part of a high-frequency radio frequency receiver. An exemplary high-frequency received signal may be r(f₀,t)=s_{I}(t)cos(2πf₀t)+s_{Q}(t)sin(2πf₀t)=s_{I}(t)cos(w₀t)+s_{Q}(t)sin(w₀t), where f₀ may be the carrier frequency and 2πf₀=w₀ may be the corresponding angular frequency. The signals s_{I}(t) and s_{Q}(t) may be, for example, the information-bearing in-phase and quadrature baseband signals that may be modulated onto the carriers cos(w₀t) and sin(w₀t). In some instances, the received signal r(t) may be at a high carrier frequency, for example, f₀=60 GHz. In these instances, it may be difficult to generate a local oscillator signal c_{LO}, for example with a Phase-locked loop (PLL), sufficiently high in frequency to achieve demodulation to baseband or, in some instances, to an intermediate frequency. In addition, high frequency LO signals may generally be undesirable for distribution in a system since the signal transport over conductors may result in transmission line problems, due to the LO signal's high frequency content. Hence, it may be desirable to generate the high frequency signal for demodulation of the RF signal in proximity to the received high frequency signal r(f₀,t). In these instances, it may be desirable to generate a local oscillator signal c_{LO} that may be significantly lower in frequency, for example, f_{LO}=20 GHz, than the carrier of the received signal at, for example f₀=60 GHz. In accordance with various embodiments of the invention, a plurality of conversion stages, for example down conversion stages 204, 206 and 208 may then be used to down convert the received signal r(t) to baseband and/or intermediate frequency.

An exemplary received signal r(t) may be amplified by a factor z in the amplifier 202 to generate a signal at the input to the quadrature generator 216a, given by r₀(f₀,t)=z·r(f₀,t)=z·[s_{I}(t)cos(w₀t)+s_{Q}(t)cos(w₀t)]. The quadrature generator 216a may generate an in-phase output r_{I}=r₀ and a quadrature output

$${r}_{Q} = {r}_{0} ( {f}_{0} , t + \frac{π}{2} )$$

generated by phase shifting r₀ by 90 degrees, as given in the following relationship:

r_{I}=s_{I}(t)cos(2πf₀t)+s_{Q}(t)sin(2πf₀t)

r_{Q}=s_{Q}(t)cos(w₀t)−s_{I}(t)sin(w₀t)

The multiplier 210a may multiply the signals r_{I}=r₀ with the local oscillator signal c_{LO}=cos(w_{LO}t), communicatively coupled via the connector label A to the output of the quadrature generator 216, to generate rₐ according to the following relationship:

$$\begin{matrix}{r}_{a} = {r}_{0} ( {f}_{0} , t ) {c}_{LO} ( {f}_{LO} , t ) \\ = z \cdot [ {s}_{I} ( t ) cos ( {w}_{0} t ) + {s}_{Q} ( t ) sin ( {w}_{0} t ) ] cos ( {w}_{LO} t ) \\ = \frac{z}{2} \cdot {s}_{I} ( t ) [ cos ( {w}_{0} t + {w}_{LO} t ) + cos ( {w}_{0} t - {w}_{LO} t ) ] + \\ \frac{z}{2} {s}_{Q} ( t ) [ sin ( {w}_{0} t + {w}_{LO} t ) + sin ( {w}_{0} t - {w}_{LO} t ) ]\end{matrix}$$

Hence, as illustrated in the above equation, the signal rₐ may comprise sum and difference terms at frequencies determined by the difference of the carrier frequency w₀ and the local oscillator frequency w_{LO}. In this instance, in accordance with an embodiment of the invention, it may be desirable to demodulate the received signal r(t) and hence it may be desirable to retain only the lower frequency component, modulated onto a carrier at frequency w₀−w_{LO}. This may be achieved by adding a signal r′ₐ to signal rₐ, wherein r′ₐ is a signal that may be generated by multiplying r_{Q} with a quadrature carrier in multiplier 218a, for example, c′(f_{LO},t)=sin(w_{LO}t) as given by the following relationship:

$$\begin{matrix}{r}_{a}^{′} = {r}_{Q} {c}_{LO}^{′} \\ = z \cdot [ {s}_{Q} ( t ) cos ( {w}_{0} t ) - {s}_{I} ( t ) sin ( {w}_{0} t ) ] sin ( {w}_{LO} t ) \\ = \frac{z}{2} {s}_{Q} ( t ) [ sin ( {w}_{0} t + {w}_{LO} t ) - sin ( {w}_{0} t - {w}_{LO} t ) ] - \\ \frac{z}{2} \cdot {s}_{I} ( t ) [ cos ( {w}_{0} t - {w}_{LO} t ) - cos ( {w}_{0} t + {w}_{LO} t ) ]\end{matrix}$$

The signal I1 may then be generated by subtracting r′ₐ from rₐ in adder 212a, as given by the following relationship:

I1=s_{I}(t)cos(w₀t−w_{LO}t)+s_{Q}(t)sin(w₀t−w_{LO}t) (1)

The signal I1 may be seen to be similar to r_{I}, although at a lower frequency given by the difference frequency term w₀−w_{LO} due to the frequency translation.

Similarly, Q1 may be generated according to the following relationship in multipliers 220a, 224a and adders 222a:

Q1=r_{I}c′_{LO}+r_{Q}c_{LO}=z[s_{Q}(t)cos(w₀t−w_{LO}t)−s_{I}(t)sin(w₀t−w_{LO}t)]

Hence, Q1 may be similar to r_{Q}, although at a lower frequency given by the difference frequency term w₀−w_{LO} due to the frequency translation.

In an additional down conversion stage, for example down conversion stage 206, the generated signals I1 and Q1 may be down converted further. This may be achieved in a similar manner by down converting I1,Q1 with a frequency-divided local oscillator signal. Specifically, as illustrated in FIG. 2, the down converted output signal I1,Q1 from down conversion stage 204 may be multiplied in multiplier 210b with a signal that may be a frequency divided version of the local oscillator at the output of the frequency divider 214b, namely

$${c}_{LO / {N}_{1}} = cos ( \frac{{w}_{LO}}{{N}_{1}} t ) .$$

The divisor, N₁, applied in frequency divider 214b may be arbitrary. In many instances, it may be desirable to choose N₁ a rational number or an integer.

Similar to generating I1 and Q1, I2 and Q2 at the output of the down conversion stage 206 may be generated by adding suitable frequency translated signals in adder 212b and adder 222b, which may remove the higher frequency components. The signal I2 may be given by the following relationship:

$$I 2 = z [ {s}_{I} ( t ) cos ( {w}_{0} t - {w}_{LO} t - \frac{{w}_{LO}}{{N}_{1}} t ) + {s}_{Q} ( t ) sin ( {w}_{0} t - {w}_{LO} t - \frac{{w}_{LO}}{{N}_{1}} t ) ]$$

Correspondingly, Q2 may be given by the following relationship:

$$\begin{matrix}Q = I 1 \cdot {c}_{LO}^{′} + Q 1 \cdot {c}_{LO} \\ = z [ \begin{matrix}{s}_{Q} ( t ) cos ( {w}_{0} t - {w}_{LO} t - \frac{{w}_{LO}}{{N}_{1}} t ) + \\ {s}_{I} ( t ) sin ( {w}_{0} t - {w}_{LO} t - \frac{{w}_{LO}}{{N}_{1}} t )\end{matrix} ]\end{matrix}$$

Further down modulating may be achieved by applying further down conversion stages similar to down conversion stage 206, for example. As illustrated in FIG. 2, it may be desirable to use a cascade of K down conversion stages. In this case, the output signals IK and QK after K down conversion stages may be given, for example, by the following relationship:

$$IK = z [ {s}_{I} ( t ) cos ( {w}_{0} t - {w}_{LO} ( 1 + {\sum }_{k = 1}^{K - 1} \frac{1}{{\prod }_{n = 1}^{k} {N}_{n}} ) t ) + {s}_{Q} ( t ) sin ( {w}_{0} t - {w}_{LO} ( 1 + {\sum }_{k = 1}^{K - 1} \frac{1}{{\prod }_{n = 1}^{k} {N}_{n}} ) t ) ] \\ QK = z [ {s}_{Q} ( t ) cos ( {w}_{0} t - {w}_{LO} ( 1 + {\sum }_{k = 1}^{K - 1} \frac{1}{{\prod }_{n = 1}^{k} {N}_{n}} ) t ) + {s}_{I} ( t ) sin ( {w}_{0} t - {w}_{LO} ( 1 + {\sum }_{k = 1}^{K - 1} \frac{1}{{\prod }_{n = 1}^{k} {N}_{n}} ) t ) ] \qquad ( 2 )$$

In these instances, it may be that the adders 212 in the down conversion stages, for example adders 212a/b/c may be configured in order to attenuate the higher frequency component at their input. In this instance, Nₖ>0∀kε1,2, . . . K−1.

In some instances and for some down conversion stages, it may be desirable to choose to retain the higher frequency component rather than the lower frequency component of the output signal of the multiplier, in order to get a desirable output at the filter. For example, in accordance with various embodiments of the invention, the higher frequency component in I1, equation (1), for example, may be retained by adding r′ₐ to rₐ in adder 212a. In this instance, from equation (1), I1 may be given by the following relationship:

I1=s_{I}(t)cos(w₀t+w_{LO}t)+s_{Q}(t)sin(w₀t+w_{LO}t) (3)

In a general case, either the higher or the lower frequency component may be selected to be retained for each down conversion stage, for Ik and/or Qk, for any k. As illustrated in equation (3), this may result in the sign of the frequency term corresponding to a particular down conversion stage to change. Hence, for K down conversion stages, the output r_{K} may be described by equation (2), wherein the coefficients Nₖ may be positive or negative, as appropriate.

In one embodiment of the invention, the divisors Nₖ may be chosen equal, so that Nₖ=N∀k. In these instances, for example IK in equation (2) may be given by the following relationship:

$$IK = z [ {s}_{I} ( t ) cos ( {w}_{0} t - {w}_{LO} t {\sum }_{k = 0}^{K - 1} {( \frac{1}{N} )}^{k} ) + {s}_{Q} ( t ) sin ( {w}_{0} t - {w}_{LO} t {\sum }_{k = 0}^{K - 1} {( \frac{1}{N} )}^{k} ) ] \qquad ( 4 )$$

It may be observed that the expression in equation (4) may be stable and converge for an arbitrary number of stages when |1/N|<1, so that the limit of (4) may be given by the following relationship, from equation (4):

$$IK {\vert}_{z = 1} {}^{K -> ∞} {s}_{I} ( t ) cos ( {w}_{0} t - \frac{N \cdot {w}_{LO} t}{N - 1} ) + {s}_{Q} ( t ) sin ( {w}_{0} t - \frac{N \cdot {w}_{LO} t}{N - 1} ) \qquad ( 5 )$$

where equation (5) may converge more rapidly for larger N. For example, if N=4, the frequency term in equation (5) may converge to w₀t−1. 3̅·w_{LO}t as K→∞. However, as may be observed from the first line of equation (5), with K=3, the frequency term may already be w₀t−1.3125·w_{LO}t and hence the frequency correction term may be approximately

$$\frac{1.3125}{1. \overline{3}} = 63 / 64 \approx 98.5 \%$$

of the desired frequency correction term.

In accordance with various embodiments of the invention, the number of down conversion stages may be arbitrary. Moreover, in some instances, it may be desirable that for the first down conversion stage, for example down conversion stage 204 may use a fractional LO, similar to down conversion stages 206 or 208, for example. The number of down conversion stages K may be determined, for example, based on the difference between w₀ and w_{LO}, and the desired intermediate frequencies. In some instances, it may be possible that the divisors may be software-programmable. Moreover, the structure illustrated in FIG. 2 may be used by a modulator, whereby the sum terms instead of the difference terms may be retained in order to obtain an output signal at a higher frequency that the input signal. For example, in equation (1), the higher frequency component may be retained by the adder 212b in the down conversion stage 206, whereby the down conversion stage 206 may effectively become an up conversion stage, as illustrated in equation (3) and described above.

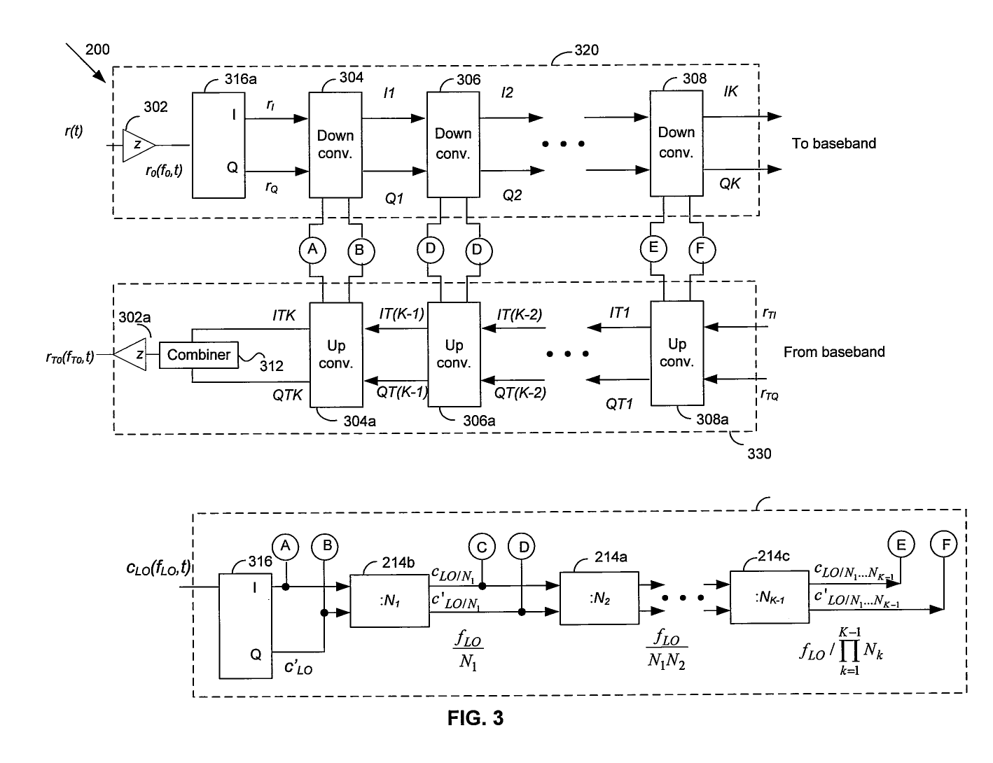

FIG. 3 is a block diagram of an exemplary RF modulator and demodulator for a high-frequency transceiver, in accordance with an embodiment of the invention. Referring to FIG. 3, there is shown a modulator/demodulator system 300 comprising a demodulator 320 and a modulator 330. The demodulator 320 may be substantially similar to the demodulator 200 illustrated in FIG. 2. The elements of demodulator 320 may be similar to their corresponding elements in demodulator 200. Specifically, elements 302, 304, 306, 308, and 316a may be similar to elements 202, 204, 206, 208, and 216a, respectively.

The modulator 330 may comprise an amplifier 302a, a combiner 312 and a plurality of up conversion stages, of which up conversion stages 304a, 306a and 308a may be illustrated. The modulator 330 may comprise suitable logic, circuitry and/or code that may be enabled to modulate an in-phase input signal, r_{TI}, and an quadrature input signal, r_{TQ}, to radio frequency and/or intermediate frequency in-phase signal ITK and to radio frequency and/or intermediate frequency quadrature signal QTK, respectively. The signal sub-script ‘T’ may indicate a transmit signal associated with the modulator 330. The combiner 312 may comprise suitable circuitry, logic and/or code that may be enabled to combine the in-phase and quadrature signal paths in a suitable manner for radio transmission. There is also shown a transmit signal r_{T0}(f_{T0},t)=r_{T0} that may be a function of frequency f_{T0} and time t. The indices for frequency and time may be dropped for illustrative purposes. Similarly, there is shown IT1,QT1,IT(K−2) QT(K−2),IT(K−1)QT(K−2), which may be the output signals of up conversion stages 1,(K−1) and K, respectively.

The functionality of the modulator 330 may be considered similar to the demodulator 320 functionality in reverse. In particular, whereas in the demodulator 320, the input signal r₀ may be a signal modulated onto a radio frequency carrier or an intermediate frequency carrier for frequency translation to a lower frequency, the input signals of the modulator 330, r_{TI} and r_{TQ}, may be baseband signals or intermediate frequency signals for frequency translation to a higher frequency, for example to intermediate frequency or radio frequency, respectively. However, the frequency up conversion may be achieved similarly to the frequency down conversion. The main difference may be found in the addition that may be performed, wherein the higher frequency components may be retained, as described for equation (3) and FIG. 2 above. For example, in up conversion stage 308a, the output signal IT1 may found from the following relationship:

$$IT 1 = {x}_{I} ( t ) cos ( {w}_{T 0} t + \frac{{w}_{LO}}{{\prod }_{n = 1}^{K - 1} {N}_{n}} t ) + {x}_{Q} ( t ) sin ( {w}_{T 0} t + \frac{{w}_{LO}}{{\prod }_{n = 1}^{K - 1} {N}_{n}} t ) \qquad ( 6 )$$

where w_{T0}=2πf_{T0} may be the angular frequency of the input signal r_{TI}=x_{I}(t)cos(w_{T0}t)+x_{Q}(t)cos(w_{T0}t), wherein x_{I}(t) and x_{Q}(t) may be the information bearing in-phase baseband signal and the quadrature baseband signal, respectively (or, in some instances, intermediate frequency) signal, similar to s(t) for the received signal. Similarly, in analogy to the relationship between r_{I} and r_{Q}, the signal r_{TQ} may be given by r_{TQ}=x_{Q}(t)cos(w_{T0}t)−x_{I}(t)sin(w_{T0}t) and QT1 may be given by the following relationship:

$$Q 1 = {x}_{Q} ( t ) cos ( {w}_{T 0} t + \frac{{w}_{LO}}{{\prod }_{n = 1}^{K - 1} {N}_{n}} t ) - {x}_{I} ( t ) sin ( {w}_{T 0} t + \frac{{w}_{LO}}{{\prod }_{n = 1}^{K - 1} {N}_{n}} )$$

Similarly, the signals may be up converted further in additional up conversion stages, for example up conversion stages 304a and 306a. The output upconversion stage K, that is 304a, may be given, for example, by the following relationship:

$$ITK = {x}_{I} ( t ) cos ( {w}_{T 0} t + {w}_{LO} ( 1 + {\sum }_{k = 1}^{K - 1} \frac{1}{{\prod }_{n = 1}^{k} {N}_{n}} ) t ) + {x}_{Q} ( t ) sin ( {w}_{T 0} t + {w}_{LO} ( 1 + {\sum }_{k = 1}^{K - 1} \frac{1}{{\prod }_{n = 1}^{k} {N}_{n}} ) t )$$

$$QTK = {x}_{Q} ( t ) cos ( {w}_{0} t + {w}_{LO} ( 1 + {\sum }_{k = 1}^{K - 1} \frac{1}{{\prod }_{n = 1}^{k} {N}_{n}} ) t ) - {x}_{I} ( t ) sin ( {w}_{T 0} t - {w}_{LO} ( 1 + {\sum }_{k = 1}^{K - 1} \frac{1}{{\prod }_{n = 1}^{k} {N}_{n}} ) t )$$

In some instances, the output signals of the up conversion stage 304a may be combined for transmission in combiner 312.

In accordance with an embodiment of the invention, the modulator 330 may share the frequency dividers, for example frequency dividers 314b/c, with the demodulator 320. The modulator 330 may be configured in a manner that may provide the same up conversion frequency steps that may be provided in the down conversion. In particular, if the adder in a down conversion stage may retain the lower frequency component, by retaining the higher frequency component in the corresponding up conversion stage, the up conversion signal may be upconverted in frequency by the same amount as a down conversion signal may be downconverted in frequency by the corresponding down conversion stage. For example, as described for FIG. 2, the signal r₁ may be down converted from angular frequency w₀ to w₁=w₀−w_{LO} for signal I1 in down conversion stage 304. Similarly, the signal IT(K−1) at angular frequency w_{T(K-1)} may be converted by the corresponding up conversion stage 304a to angular frequency w_{TK}=w_{T(K-1)}+w_{LO}. Hence, by appropriately choosing the summation in both the demodulator 320 and the modulator 330, the frequency translation across the entire modulator may be chosen approximately equal across the entire demodulator, for example, in opposite directions. In one exemplary embodiment of the invention, the signal r_{I}/r_{Q}, for example, may be down converted by 40 GHz, and the transmit signal r_{TI}/r_{TQ} may be up converted by 40 GHz r_{TK}.

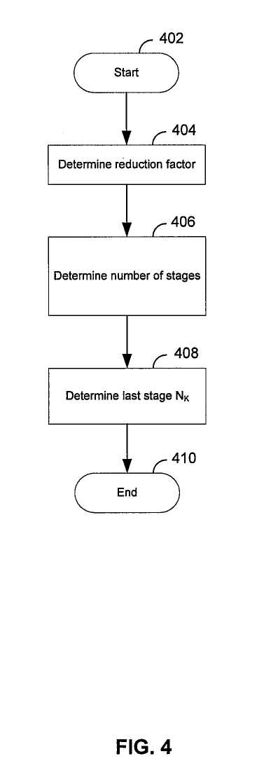

FIG. 4 is a flowchart, illustrating an exemplary determination of the down conversion factors of a demodulator, in accordance with an embodiment of the invention. In accordance with the description for FIG. 2 and FIG. 3, it is understood by one skilled in the art that there are a large number of approaches that may be chosen to determine a number of frequency conversion stages and appropriate frequency conversion factors. With reference to FIG. 4, there is shown one approach that may be used to determine a number of frequency conversion stages and the associated conversion factors and/or divisors.

In accordance with an exemplary embodiment of the invention, determination of a down conversion system, for example a demodulator similar to FIG. 2, may be illustrated in FIG. 4. Initially, in step 404, a reduction factor may be determined. The reduction factor, for example x, may be determined by the difference between the frequency of the carrier of the received signal, w₀, and the desired carrier frequency at the output of the demodulator, w_{K}. The reduction factor may be expressed in terms of local oscillator frequency, as given by the following relationship:

$$x = \frac{{w}_{0} - {w}_{K}}{{w}_{LO}}$$

Based on the reduction factor, the number of stage stages according to this exemplary approach may be determined as given by the following relationship, in step 406:

K=┌x┐

where the operation ┌.┐ may denote ‘the nearest greater integer’. In this instance, for K conversion stages, K−1 conversion stages may be chosen such that Nₖ=1∀kε0,1, . . . K−1. The down conversion factor N_{K} of the K-th down conversion stage may correspondingly be chosen, in step 408, as 0<N_{K}<1 and may be given by the following relationship:

$${N}_{K} \approx \frac{1}{x - ⌊ x ⌋}$$

where the operation └.┘ may denote ‘the nearest smaller integer’, and the operation ‘≈’ may be interpreted as ‘a sufficiently close rational number’, in accordance with the accuracy that may be required in the system.

In an exemplary embodiment of the invention, in instances where w₀ may be 60 GHz, the target frequency w_{K} may be 1 GHz, and the local oscillator frequency w_{LO} may be 8 GHz, x=7.375. Hence, it may be desirable to use K=8 stages. Hence,

$${N}_{k} = 1 ∀ k ∈ 0 , 1 , … 6 and {N}_{K - 1} = 0.375 = \frac{3}{8} .$$

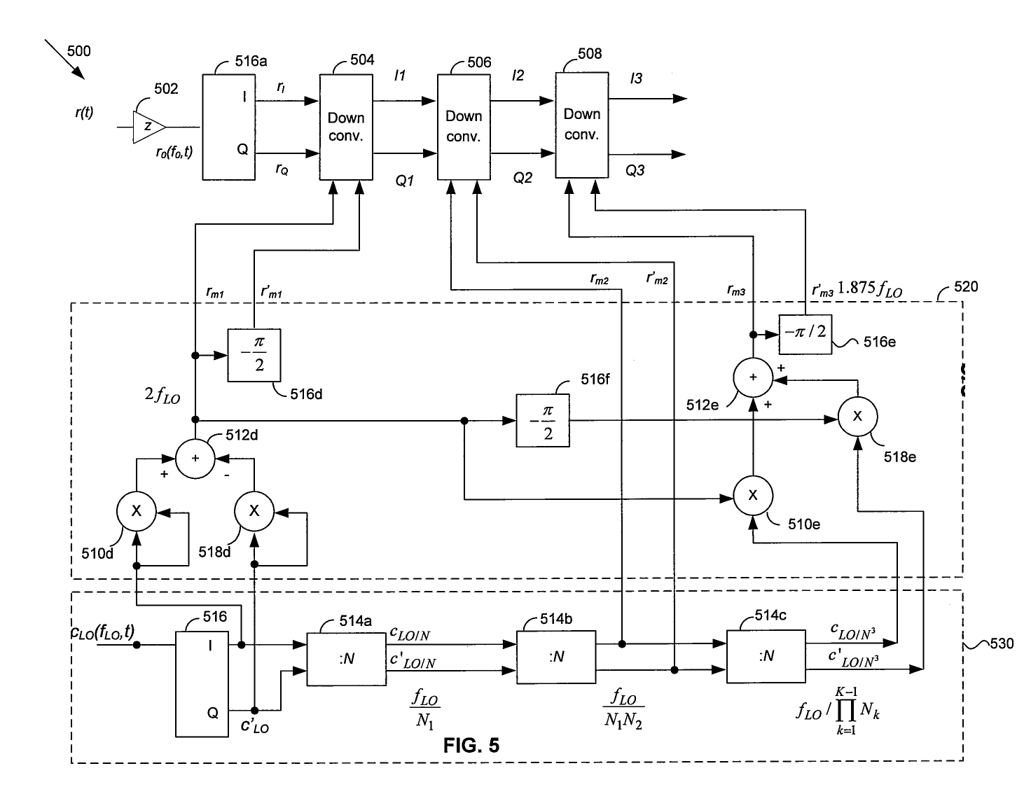

FIG. 5 is a diagram of an exemplary demodulator with local oscillator frequency mixing, in accordance with an embodiment of the invention. Referring to FIG. 5, there is shown a demodulation system 500 comprising an amplifier 502, down conversion stages 504, 506 and 508, an LO mixer 520 and a fractional LO cascade 530. The down conversion stages 504, 506 and 508 may be substantially similar to the down conversion stages 204, 206 and 208 in FIG. 2. The LO mixer 520 may comprise adders 512d/e, multipliers 510d/e and 518d/e and phase shifters 516d/e/f. The fractional LO cascade 530 may comprise frequency dividers 514a/b/c and quadrature generator 516. There is also shown a received signal r₀(f₀,t)=r₀ that may be a function of a receive carrier frequency f₀ and time t. The indices for frequency and time may be dropped for illustrative purposes. Similarly, there is shown r₁,r_{Q},I1,Q1,I2,Q2,I3,Q3,rₘ₁,rₘ₂,rₘ₃ and r′ₘ₁,r′ₘ₂,r′ₘ₃, similar to the description of FIG. 2. A local oscillator signal c_{LO}(f_{LO},t)=c_{LO} may be shown and a number of frequency terms

$$\frac{{f}_{LO}}{{N}_{1}} , \frac{{f}_{LO}}{{N}_{1} {N}_{2}} and \frac{{f}_{LO}}{{\prod }_{k = 1}^{K} {N}_{k}} ,$$

which may illustrate various signals generated by frequency dividing the local oscillator (LO) signal c_{LO}, for example, c_{LO}(f_{LO}/N,t), c_{LO}(f_{LO}/N²,t) and c_{LO}(f_{LO}/N³,t).

In some instances, the type of frequency divider, for example 214b/c, may be constrained due to a particular implementation. For example, it may be possible that Nₖε□⁺. In this regard, the divisors may be chosen from among the set of positive integers. In another embodiment of the invention illustrated in FIG. 5, the frequency divider may be more constrained and Nₖ=N∀k, for example. Notwithstanding, in accordance with an embodiment of the invention, high precision may be achieved even for fixed Nₖ=N, in some instances at the expense of an LO mixer 520. For example, when N=Nₖ=2∀k, from equation (5), for example, one may see that the frequency term may converge to

$$K -> ∞ : {w}_{0} t - \frac{N}{N - 1} \cdot {w}_{LO} t - 2 {w}_{LO} t .$$

For different number of stages K, it may be seen from the following table how the term correction term

$$\frac{N}{N - 1}$$

may converge to 2 with K:

| K | $Correction term \frac{N}{N - 1}$ | Error termw.r.tK = ∞ (in %) | Differencebetweenadjacent stages |
|---|---|---|---|
| 0 | 1 | 50 | 1 |
| 1 | 1.5 | 25 | 0.5 |
| 2 | 1.75 | 12.5 | 0.25 |
| 3 | 1.875 | 6.25 | 0.125 |
| 4 | 1.9375 | 3.125 | 0.0625 |
| 5 | 1.96875 | 1.5625 | 0.03125 |
| 6 | 1.984375 | 0.78125 | 0.015625 |
| 7 | 1.992188 | 0.390625 | 0.007813 |
| 8 | 1.996094 | 0.195313 | 0.003906 |
| 9 | 1.998047 | 0.097656 | 0.001953 |
| 10 | 1.999023 | 0.048828 | 0.000977 |

Hence, as may be seen from the above second column, by increasing the number of down conversion stages, the correction term may be chosen arbitrarily close to 2, as may be seen from column 3 of the above table. For example, for K=2, a 12.5% error with respect to K=∞ may be obtained. Hence, in cases where the correction term

$$\frac{N}{N - 1}$$

may be chosen as an integer greater or equal to 2, arbitrary accuracy may be achieved. For example in the system illustrated in FIG. 2 a correction factor of 5=3+2 may be approximated choosing stages Nₖ=1; kε0,1,2, to obtain the factor 3, followed by an arbitrary number of stages with Nₖ=2•k: k>2, which may get arbitrarily close to 5.

In order to generate arbitrary frequency correction terms based on a fixed divisor factor Nₖ=N∀k, an LO mixer 520 may be used together with the fractional LO cascade 530. The fractional LO cascade 530 may comprise suitable logic, circuitry and/or code that may be enabled to accept a local oscillator input signal c_{LO}(f_{LO},t) and frequency divide it in a cascade of frequency dividers, for example 514a/b/c, to generate fractional local oscillator signals, for example c_{LO}(f_{LO}/N,t),c_{LO}(f_{LO}/N²,t) and c_{LO}(f_{LO}/N³,t), respectively. By appropriately mixing these fractional local oscillator signals, small frequency differences may be generated that may be used in the down conversion stages. The resolution, or frequency steps, obtainable may depend on the number of frequency dividers in the fractional LO cascade 530. For example, the exemplary embodiment illustrated in FIG. 5 may comprise 3 frequency dividers 514a/b/c and N=2 may be set. By appropriately multiplying and adding various fractional LO terms obtained in the fractional LO cascade 530 in the LO mixer 520, arbitrary down conversion factors may be achieved in the down conversion stages, for a sufficient number of frequency dividers in the LO cascade 530.

For example, the exemplary embodiment illustrated in FIG. 5 may result in an overall down conversion factor of 4.125, that is, r₃∝s₁(t)cos(w₀t−4.125w_{LO}t)+s_{Q}(t)sin(w₀t−4.125w_{LO}t). In the LO mixer 520, the multiplier 510d may be communicatively coupled to c_{LO}, and the output of the multiplier 510d may be given by the following relationship:

$${c}_{LO} \cdot {c}_{LO} = {cos}^{2} ( {w}_{LO} t ) = \frac{1}{2} [ cos ( 2 {w}_{LO} t ) + 1 ]$$

Similarly, the output of the multiplier 518d may be given by the following relationship:

$${c}_{LO}^{′} \cdot {c}_{LO}^{′} = {sin}^{2} ( {w}_{LO} t ) = \frac{1}{2} [ 1 - cos ( 2 {w}_{LO} t ) ]$$

And hence the output of the adder 512d, may be given by the following relationship:

c_{LO}·c_{LO}−c′_{LO}·c′_{LO}=cos(2w_{LO}t)

Therefore, similar to the adders described for FIG. 2, the adder 512d may retain the low-frequency or high frequency component. In this particular instance, the adder 512d may retain the high-frequency component.

In order to use the output signal generated by the output of the adder 512d, the output of the adder 512d may be communicatively coupled to a phase shifter 516d that may generate a quadrature clock output that may be 90 degrees phase shifted versions of its input signal. The output of the phase shifter 516d may be communicatively coupled to the down conversion stage 504. Hence, in accordance with various embodiments of the invention and the description for FIG. 2 and FIG. 3, the output signals rₘ₁,r′ₘ₁ of the mixer 520 may be given by the following relationship:

rₘ₁=cos(2w_{LO}t)

r′ₘ₁=cos(2w_{LO}t−π/2)=sin(2w_{LO}t)

The signals rₘ₁ and r′ₘ₁ may be coupled to the down conversion stage 504. Similarly, the output of frequency divider 514b may be coupled to the input of the down conversion stage 506, so that

$${r}_{m 2} = {c}_{LO} ( \frac{{w}_{LO}}{{N}^{2}} , t ) .$$

It may be observed from FIG. 5 that the output of frequency divider 514b may be directly coupled to the down conversion stage 506 and may not be mixed beforehand in the LO mixer 520. Similarly, it may be observed that the output of the frequency divider 514a may not be coupled to the LO mixer 520 or a down conversion stage, in this embodiment of the invention. Instead, the output of frequency divider 514a may be used as the input to the frequency divider 514b.

The output of the frequency divider 514c may be communicatively coupled to an input of the multiplier 510e. The second input of the multiplier 510e may be coupled to the output of the adder 512d. The output of the adder 512d may be rₘ₁. Hence, the output of the multiplier 510e in the LO mixer may be described by the following relationship:

$$\begin{matrix}{c}_{LO / {N}^{3}} \cdot {r}_{m 1} = cos ( 2 {w}_{LO} t ) cos ( \frac{{w}_{LO}}{{N}^{3}} t ) \\ = \frac{1}{2} [ cos ( 2 {w}_{LO} t + \frac{{w}_{LO}}{{N}^{3}} t ) + cos ( 2 {w}_{LO} t - \frac{{w}_{LO}}{{N}^{3}} t ) ]\end{matrix} \qquad ( 8 )$$

Similarly, the output of the multiplier 518e may be given by the following relationship:

$$\begin{matrix}{c}_{LO / {N}^{3}}^{′} \cdot {r}_{m 1}^{′} = sin ( 2 {w}_{LO} t ) sin ( \frac{{w}_{LO}}{{N}^{3}} t ) \\ = \frac{1}{2} [ cos ( 2 {w}_{LO} t - \frac{{w}_{LO}}{{N}^{3}} t ) + cos ( 2 {w}_{LO} t + \frac{{w}_{LO}}{{N}^{3}} t ) ]\end{matrix}$$

By retaining the lower frequency component from the output signal of 510e in the adder 512e, the output signal of the filter 512e may be given by the following relationship:

$$\begin{matrix}{r}_{m 3} = {c}_{LO / {N}^{3}} \cdot {r}_{m 1} + {c}_{LO / {N}^{3}}^{′} \cdot {r}_{m 1}^{′} \\ = cos ( 2 {w}_{LO} t - \frac{{w}_{LO}}{8} t ) \\ = cos ( 1.875 {w}_{LO} t )\end{matrix}$$

In the down conversion stage 504, the output signals I1/Q1 may be given by the following relationship:

I1=z[s_{I}(t)cos(w₀t−2w_{LO}t)+s_{Q}(t)sin(w₀t−2w_{LO}t)]

Q1=z[s_{Q}(t)cos(w₀t−2w_{LO}t)−s_{I}(t)sin(w₀t−2w_{LO}t)]

where the down conversion stage 504 may be configured to retain the lower frequency component and r₀=s_{I}(t)cos(w₀t)+s_{Q}(t)sin(w₀t), for example. z may be the amplification factor introduced by amplifier 502, similar to the description for FIG. 2. Correspondingly, the outputs of the down conversion stage 506 may be given by the following relationship:

$$I 2 = z [ {s}_{I} ( t ) cos ( {w}_{0} t - 2 {w}_{LO} t - \frac{{w}_{LO} t}{4} ) + {s}_{Q} ( t ) sin ( {w}_{0} t - 2 {w}_{LO} t - \frac{{w}_{LO} t}{4} ) ]$$

$$Q 2 = z [ {s}_{Q} ( t ) cos ( {w}_{0} t - 2 {w}_{LO} t - \frac{{w}_{LO} t}{4} ) - {s}_{I} ( t ) sin ( {w}_{0} t - 2 {w}_{LO} t - \frac{{w}_{LO} t}{4} ) ]$$

whereby the down conversion stage 506 may be configured to retain the lower frequency component. The output of the down conversion stage 508 may be given by the following relationship:

$$I 3 = z [ {s}_{I} ( t ) cos ( {w}_{0} t - 2 {w}_{LO} t - \frac{{w}_{LO} t}{4} - 1.875 {w}_{LO} t ) + {s}_{Q} ( t ) sin ( {w}_{0} t - 2 {w}_{LO} t - \frac{{w}_{LO} t}{4} - 1.875 {w}_{LO} t ) ]$$

$$Q 3 = z [ {s}_{Q} ( t ) cos ( {w}_{0} t - 2 {w}_{LO} t - \frac{{w}_{LO} t}{4} - 1.875 {w}_{LO} t ) - {s}_{I} ( t ) sin ( {w}_{0} t - 2 {w}_{LO} t - \frac{{w}_{LO} t}{4} - 1.875 {w}_{LO} t ) ]$$

Hence, as described above, the output signals I3 and Q3 that may be generated by the down conversion stages 504, 506 and 508, may be frequency translated by a factor of 4.125. By appropriately choosing the number of frequency dividers in the fractional LO cascade 530 and suitably combining the outputs of the frequency dividers in the LO mixer 520, an arbitrary down conversion (frequency translation) factor may be achieved. In various embodiments of the invention, a similar approach may be used for a modulator by appropriate filtering in the conversion stages 504, 506 and 508, as described above and with respect to FIG. 2.

In accordance with an embodiment of the invention, a method and system for distributed quadrature transceiver using phase shifting may comprise frequency-translating a first signal, for example r₀, to generate a second signal and a third signal, for example IK and QK, respectively, utilizing a plurality of conversion stages, for example conversion stages 304, 306 and 308, wherein in at least one of said plurality of conversion stages, a first frequency scaled signal, for example rₐ, and a second frequency scaled signal, for example r′ₐ, may be summed. The first frequency scaled signal may be generated by multiplying a corresponding input signal with a local oscillator signal, for example c_{LO}, or a fractional local oscillator signal, for example c_{LO/N}, and the second frequency scaled signal may be generated by multiplying a phase-shifted version of the corresponding input signal with a phase-shifted version of the local oscillator signal or a phase-shifted version of the fractional local oscillator signal, as illustrated in FIG. 2. A third frequency scaled signal and a fourth frequency scaled signal may be summed, for example in the adder 222a illustrated in FIG. 2. The third frequency scaled signal may be generated by multiplying the corresponding input signal with the phase-shifted version of the local oscillator signal or the phase-shifted version of the fractional local oscillator signal, and the fourth frequency scaled signal may be generated by multiplying the phase-shifted version of the corresponding input signal with the local oscillator signal or the fractional local oscillator signal, as illustrated in FIG. 2, FIG. 3 and FIG. 5. The first signal, for example r₀ or r_{TI} may be the corresponding input signal to at least one of the plurality of conversion stages, and the second signal and the third signal may be generated from one or more output signals of the plurality of conversion stages, for example IK,QK or ITK and QTK.

The plurality of conversion stages, for example 504, 506 and 508, may be communicatively coupled in a cascade configuration. The first signal may be a radio frequency signal, for example r₀, or an intermediate frequency signal and the second signal, for example IK, and/or third signal, for example QK, may be baseband signals, as illustrated in FIG. 2, FIG. 3 and FIG. 5. The first signal may be a radio frequency signal or a baseband signal and the second signal and/or third signal may be intermediate frequency signals. The first signal may be a baseband signal or an intermediate frequency signal and the second signal and/or third signal are may be a radio frequency signal. The local oscillator signal c_{LO} may be associated with a local oscillator frequency, for example f_{LO}, and the fractional local oscillator signal, for example c_{LO/N}, may be associated with a fraction of the local oscillator frequency, for example f_{LO}/N. The fractional local oscillator signal may be generated from the local oscillator signal by using one or more frequency dividers, for example 214a/b/c as illustrated in FIG. 3. The local oscillator signal and/or one or more mixing signals may be mixed to generate the fractional local oscillator signal, for example in a mixer 520. The local oscillator signal may be divided via one or more frequency dividers to generate the one or more mixing signals, as illustrated in FIG. 5. The local oscillator signal may be a sinusoidal signal with a frequency equal to the local oscillator frequency.

Another embodiment of the invention may provide a machine-readable storage, having stored thereon, a computer program having at least one code section executable by a machine, thereby causing the machine to perform the steps as described above for a method and system for distributed quadrature transceiver using phase shifting.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals, the method comprising:
frequency-translating a first signal to generate a second signal and a third signal, utilizing a plurality of conversion stages, wherein in at least one of said plurality of conversion stages:
a first frequency scaled signal and a second frequency scaled signal are summed, where said first frequency scaled signal is generated by multiplying a corresponding input signal with a local oscillator signal or a fractional local oscillator signal, and said second frequency scaled signal is generated by multiplying a phase-shifted version of said corresponding input signal with a phase-shifted version of said local oscillator signal or a phase-shifted version of said fractional local oscillator signal; and
a third frequency scaled signal and a fourth frequency scaled signal are summed, where said third frequency scaled signal is generated by multiplying said corresponding input signal with said phase-shifted version of said local oscillator signal or said phase-shifted version of said fractional local oscillator signal, and said fourth frequency scaled signal is generated by multiplying said phase-shifted version of said corresponding input signal with said local oscillator signal or said fractional local oscillator signal, wherein said first signal is said corresponding input signal to at least one of said plurality of conversion stages, and said second signal and said third signal are generated from one or more output signals of said plurality of conversion stages.

2. The method according to claim 1, wherein said plurality of conversion stages are communicatively coupled in a cascade configuration.

3. The method according to claim 1, wherein said first signal is a radio frequency signal or an intermediate frequency signal and said second signal and/or third signal are baseband signals.

4. The method according to claim 1, wherein said first signal is a radio frequency signal or a baseband signal and said second signal and/or third signal are intermediate frequency signals.

5. The method according to claim 1, wherein said first signal is a baseband signal or an intermediate frequency signal and said second signal and/or third signal are radio frequency signals.

6. The method according to claim 1, wherein said local oscillator signal is associated with a local oscillator frequency and said fractional local oscillator signal is associated with a fraction of said local oscillator frequency.

7. The method according to claim 6, comprising generating said fractional local oscillator signal from said local oscillator signal by using one or more frequency dividers.

8. The method according to claim 6, comprising mixing said local oscillator signal and/or one or more mixing signals to generate said fractional local oscillator signal.

9. The method according to claim 8, comprising dividing said local oscillator signal via one or more frequency dividers to generate said one or more mixing signals.

10. The method according to claim 6, wherein said local oscillator signal is a sinusoidal signal with a frequency equal to said local oscillator frequency.

11. A system for processing communication signals, the system comprising:
one or more circuits, said one or more circuits are enabled to frequency-translate a first signal to generate a second signal and a third signal utilizing a plurality of conversion stages, wherein in at least one of said plurality of conversion stages:
a first frequency scaled signal and a second frequency scaled signal are summed, where said first frequency scaled signal is generated by multiplying a corresponding input signal with a local oscillator signal or a fractional local oscillator signal, and said second frequency scaled signal is generated by multiplying a phase-shifted version of said corresponding input signal with a phase-shifted version of said local oscillator signal or a phase-shifted version of said fractional local oscillator signal; and
a third frequency scaled signal and a fourth frequency scaled signal are summed, where said third frequency scaled signal is generated by multiplying said corresponding input signal with said phase-shifted version of said local oscillator signal or said phase-shifted version of said fractional local oscillator signal, and said fourth frequency scaled signal is generated by multiplying said phase-shifted version of said corresponding input signal with said local oscillator signal or said fractional local oscillator signal, wherein said first signal is said corresponding input signal to at least one of said plurality of conversion stages, and said second signal and said third signal are generated from one or more output signals of said plurality of conversion stages.

12. The system according to claim 11, wherein said plurality of conversion stages are communicatively coupled in a cascade configuration.

13. The system according to claim 11, wherein said first signal is a radio frequency signal or an intermediate frequency signal and said second signal and/or third signal are baseband signals.

14. The system according to claim 11, wherein said first signal is a radio frequency signal or a baseband signal and said second signal and/or third signal are intermediate frequency signals.

15. The system according to claim 11, wherein said first signal is a baseband signal or an intermediate frequency signal and said second signal and/or third signal are radio frequency signals.

16. The system according to claim 1, wherein said local oscillator signal is associated with a local oscillator frequency and said fractional local oscillator signal is associated with a fraction of said local oscillator frequency.

17. The system according to claim 16, wherein said one or more circuits generate said fractional local oscillator signal from said local oscillator signal by using one or more frequency dividers.

18. The system according to claim 16, wherein said one or more circuits mix said local oscillator signal and/or one or more mixing signals to generate said fractional local oscillator signal.

19. The system according to claim 18, wherein said one or more circuits divide said local oscillator signal via one or more frequency dividers to generate said one or more mixing signals.

20. The system according to claim 16, wherein said local oscillator signal is a sinusoidal signal with a frequency equal to said local oscillator frequency.
